(19) United States
(12) Patent Application Publication
(10) Pub. No.: US 2014/0057025 A1
(43) Pub. Date: Feb. 27, 2014

(54) SYSTEM FOR TREATING A FOOD PRODUCT

(71) Applicant: Govert Van Oord, Schalkwijk (NL)

(72) Inventor: Govert Van Oord, Schalkwijk (NL)

(73) Assignee: IXL Nederland B. V.

(21) Appl. No.: 14/004,340

(22) PCT Filed: Mar. 8, 2012
(86) PCT No.: PCT/NL2012/000023

§ 371 Date: Nov. 11, 2013

(30) Foreign Application Priority Data
Mar. 11, 2011 (NL) 1038667

(51) Int. Cl. A47J 27/00

(52) U.S. Cl. CPC A47J 27/00
USPC 426/244; 99/358

(57) ABSTRACT

System for treating a food product by means of PEF—Pulsed Electric Field—, in which the system comprises a treatment pan (2) and a coupling station (3) i.e. docking station of a PEF-generator; the treatment pan (2) comprising a first (8) and a second (9) passage opening, a removable cover (10), a ground electrode (11), a voltage electrode (12), a first power line (14), a second power line (15), wherein the first power line (14) extends through the first passage opening (8) to the outside and the second power line (15) extends through the second passage opening (9) to the outside; the coupling-station (3) is arranged for receiving the treatment pan (2) in the use position for the treatment of food (7), the coupling station (3) comprises connecting lines (16, 18) to the PEF-generator (17), in such a way that in the use position of the treatment pan (2) a pulsed electric field is transmitted from the PEF-generator (17) to the electrodes (11, 12) in the treatment pan (2).

The invention relates to a system for treating a food product by means of PEF—Pulsed Electric Field—, in which the system comprises a treatment pan and a coupling station i.e. docking station of a PEF-generator.

Food can be treated by applying over the food a (pulsed) electric field strength of a relatively high voltage. This method is described in Dutch patent application No. 1037939, the contents of this document are considered to be incorporated entirely in this patent application. Applying a pulsed electric field is often referred to as PEF: Pulsed Electric Field. The food to be treated is for this purpose enclosed in a chamber in which a ground electrode and a voltage electrode are arranged. These electrodes are connected to the PEF-generator, which is adapted to generate and emit a pulsed electric field. A test set-up has shown that this method for treating a food product is fast and highly effective. As a result, there is a need for a system for treating a food product that can be used in the kitchens of institutions, but also in small kitchens of private households. Furthermore the treatment system has to be user friendly and also has to be safe, and should be applicable without disadvantages for the user.

Therefore, the object of the invention is to provide for a user-friendly, easy and inexpensively producible, easy to clean, safe to use and to apply, system for treating a food product with a pulsed electric field.

This object is achieved by the invention in providing a treatment pan comprising an upright sidewall and a bottom for receiving the food to be treated, the treatment pan is provided with a first and a second passage opening, the treatment pan comprises a removable cover, a ground electrode positioned adjacent to the bottom of the treatment pan, a voltage electrode positioned near the cover of the treatment pan, thereby forming an electrode chamber between the two electrodes, a first power line connected to the earth electrode, a second power line connected to the voltage electrode, wherein the first power line extends through the first passage opening to the outside and the second power line extends through the second passage opening to the outside; the coupling-station is arranged for receiving the treatment pan in the use position for treating the food product, the coupling station comprises a first connecting line to the PEF-generator of the pulsed electric field and a second connecting line to the PEF-generator, in such a way that in the use position of the treatment pan a pulsed electric field is transmitted from the PEF-generator through the connecting lines and through the power lines to the electrodes in the preparation pan for treating the food product. By the above measures a treatment system is obtained that, in both small as well as in large kitchens, modularly can be applied, that is user-friendly because it is easy to clean, and that can be used safely because the electric lines for generating the pulsed electric field are concealed in the treatment pan and in the docking station. In this way various treatment pans can easily be coupled or docked to the coupling or docking station.

Particularly the first and the second passage opening both are provided in the bottom or in the cover of the treatment pan.

In particular the first passage opening is provided in the bottom of the treatment pan and wherein the second passage opening is provided in the cover of the treatment pan.

The passage openings can both be provided on the upper side or at the bottom side, but advantageously the ground electrode is leaded through at the bottom side of the treatment pan, and the voltage electrode is leaded through at the upper side of the treatment pan.

Preferably the cover is provided with a circumferential collar, wherein the voltage electrode is arranged against the lower edge of the circumferential collar, and wherein in the use position the circumferential collar extends into the interior of the treatment pan.

In this manner, the voltage electrode can be arranged easily upon the food to be treated in order to prevent formation of air bubbles and thereby preventing electrical breakdown through air.

In a preferred embodiment a collection chamber is provided, in the radial direction, between the circumferential collar and the upright sidewall of the treatment pan, for collecting excess liquid from the electrode chamber of the treatment pan. As a result of pressing down the voltage electrode by the circumference collar of the cover, air bubbles are removed, whereby excess fluid is collected in the collection chamber, so that the fluid will not leak out of the treatment pan during treating the food product.

The embodiment is preferred wherein the coupling station is provided with a jaw element for receiving the treatment pan.

In particular the coupling station is provided with an upper jaw element and a lower jaw element.

More in particular the cover and/or the bottom of the treatment pan is provided with one or more recesses for receiving one or more jaw elements of the coupling station.

Preferably the upper jaw element is provided with the second connecting line for electrical connection to the second power line in the recess of the cover. By provide the coupling station with jaw elements the treatment pan can be slid between these elements. By providing recesses in the cover and in the bottom of the treatment pan a correct positioning can be ensured of the treatment pan; and the electrical lines and connectors can be concealed.

Preferably a second treatment pan is provided, which is detachably provided in the first treatment pan, whereby in the use position the earth electrode, the voltage electrode and the circumferential collar of the cover are provided in the second treatment pan.

In particular the treatment pans are made of food-grade polycarbonate. By applying a second treatment pan or bowl, the pans can be cleaned more easily and they can also be manufactured from a strong, transparent, plastic such as polycarbonate. Also this configuration facilitates arranging communication means or safety means. By applying a food-grade polycarbonate a very user friendly and easy to clean food treatment system is obtained.

Preferably the electrodes are made of nickel and the electrical lines are made of bronze, in particular of phosphor bronze.

It has been found that bronze and, in particular, phosphor bronze possesses a very good conductivity for a pulsed electric field accompanied by a good corrosion resistance.

The embodiment is preferred wherein the treatment pan comprises safety, which can be read out by the coupling station so that the PEF-generator can only provide a pulsed electric field when a safe, suitable, configuration is inserted in the coupling station.

Preferably electronic means are chosen for the safety means, such as a chip that can be read out, or a communication network.

By means of safety means arranged in the treatment pan or pans, which can be read out by the coupling station, switching on of the PF-generator can be prevented when no pan or an an unsuitable pan is inserted. These means may be mechanical means, but may also be electronic means, such as a remote-readable RFID chip or a chip which, by means of a communication network, is connected to the coupling station and/or the PEF-generator.

In particular the treatment pan comprises control means, such as sensors, which can be read out by the coupling station so that the PEF-generator can provide a pulsed electric field controlled by the data of the control means. By using measurement data from the treatment pan, it is possible to improve regulation and control of the pulsed electric field.

The invention also relates to a treatment pan and a coupling station for use in the system for treating a food product.

The invention also relates to a method for treating a food product with a system.

The invention is further explained by means of a drawing and an embodiment of the system, whereby other preferred features and advantages of the invention will be apparent.

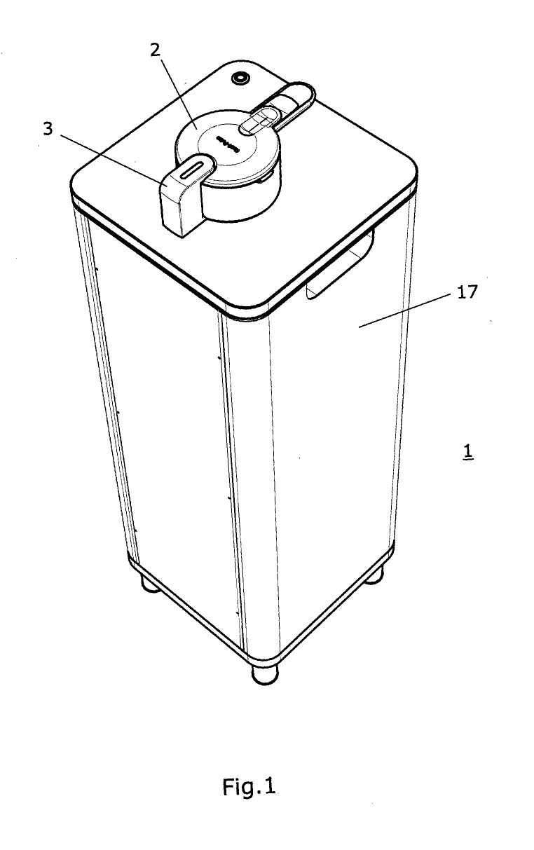

FIG. 1 shows a perspective view of the system for treating a food product according to the invention;

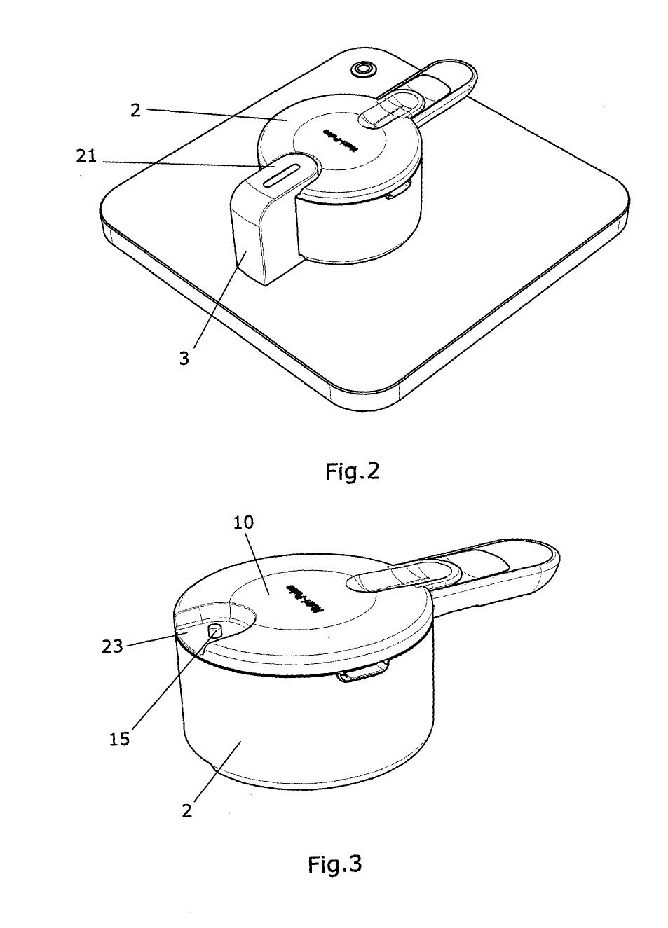

FIG. 2 shows a perspective view of the coupling station with a treatment pan arranged therein;

FIG. 3 shows the treatment pan according to the invention;

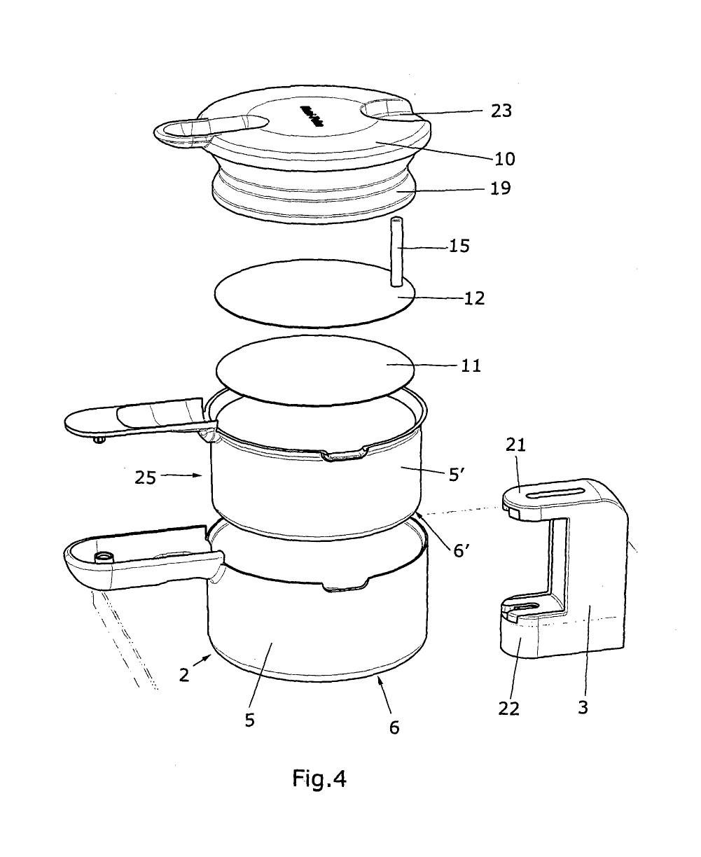

FIG. 4 shows an exploded view of the treatment pan with a coupling station;

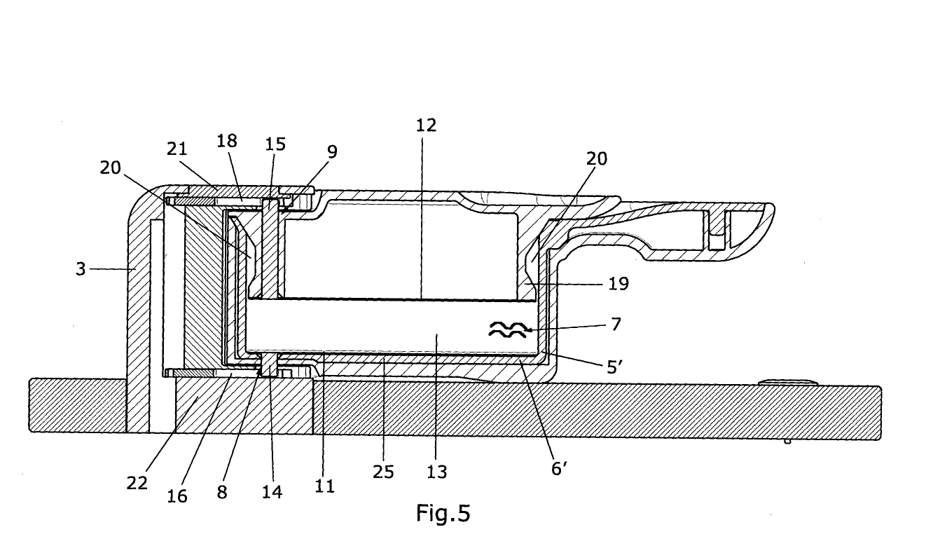

FIG. 5 shows a cross-sectional view of a treatment pan in the use position in the coupling station.

FIG. 1 shows a system 1 according to the invention for treating a food product. The system comprises a coupling station 3, a treatment pan 2 and a PEF-generator 17 with control module, which is adapted for generating a pulsed electric field

In FIG. 2 the coupling-station 3 and the treatment pan 2 inserted therein are shown in more detail. The coupling station 3 is provided with an upper jaw element 21, under which the treatment pan 2 fits.

In FIG. 3 is shown that the cover 10 of the treatment pan is provided with a recess 23 in which also the end of a power line 15 is arranged. The recess 23 is provided with a shape corresponding to the upper jaw element 21 of the coupling station 3.

In the exploded view of FIG. 4, the various elements of the treatment pan 2 are shown in more detail. In this embodiment, a treatment pan 2 with a second treatment pan or bowl 25 is shown, but this is not essential for proper operation of the system according to the invention. The treatment pan 25 is provided with a bottom 6′ and an upright side wall 5′. The ground electrode 11 is arranged at the bottom 6′ of the treatment pan. A detachable cover 10 with a circumferential collar 19 is provided at the upper side of the pan. In the use position voltage electrode 12 is located against the lower edge of the circumferential collar and is thereby pressed onto the food to be treated. Voltage electrode 12 is provided with a power line 15 in the form of a rod, which protrudes in the assembled use position through a passage opening in the recess of the cover 10. Coupling station 3 is provided with an upper jaw element 21 and a lower jaw element 22, in this embodiment both being provided with a connecting line. In alternative embodiments, both connecting lines may be provided in the upper jaw element 21 or in the lower jaw element 22.

In FIG. 5 is shown, in cross-section, a treatment pan 2 in the use position in the coupling station 3. Furthermore in this figure an embodiment is shown having a second treatment pan 25, but a single treatment pan is also included within the scoop of the invention. The treatment pan 25 is provided with a bottom 6′ and an upright side wall 5′. In the interior of the pan (i.e. the electrode chamber 13) the food product 7 to be treated is positioned on the ground electrode 11. Voltage electrode 12 is provided on top of food 7, the circumferential collar 19 of cover 10 presses the electrode 12 down. As a result, air bubbles are expelled from the electrode chamber 13 to the collection chamber 20. Collection chamber 20 is radially formed between the outer wall of the circumferential collar 19 of the cover and the inside of the upright sidewall 5′ of the treatment pan 25. From the ground electrode 11 a first power line 14 extends downwards, through the first passage opening 8, to the lower jaw element 22 of the coupling station 3. A second power line 15 extends from the voltage electrode 12 upwards, through the second passage opening 9, to upper jaw element 21 of the coupling station. When the treatment pan 2 is inserted in the correct use position between the two jaw elements 21, 22 of the coupling station, an electrical contact is made between the first power line 14 and the first connecting line 16, and between the second power line 15 and the second connecting line 18. As a result, the system is ready for imposing a pulsed electric field by means of the two electrodes 11, 12.

In order to prevent that the PEF-generator is switched on when there is no pan, —or an pan unsuitable for PEF—positioned in the coupling station, preferably safety means are arranged in the treatment pan. The coupling station can read out these safety means, so that the control module of the PEF-generator can be locked or unlocked. These means may be mechanical means, but may also be electronic means, such as a remote-readable RFID chip or a chip, which by means of a communication network, is connected to the coupling station and/or the PEF-generator.

Also, the treatment pan can be provided with control means, such as a temperature sensor or other sensors. These sensors can be in direct contact with the food or can measure variables in the treatment pan in an alternative way. The measurement data may be transmitted in a well-known manner, such as by means of the above-mentioned communication network, to the control module, so that the treatment process in the treatment pan can be controlled on the basis of the measurement data.

With a second treatment pan or bowl 25, the pans can be cleaned more easily and can also be manufactured from a strong, transparent, plastic such as polycarbonate. In

FIGS. 4 and 5 preferred embodiments are shown of a system with two, into one another insertable, treatment pans. The treatment pans are preferably manufactured from a plastic such as a food-grade polycarbonate, but any well-known flexible and readily extrudable plastic such as polypropylene-or polyethylene can be applied. By using this food-grade polycarbonate, a particularly user-friendly and easy to clean food preparation system is obtained. Using two pans also has the advantage that the communication means and the control means may be easily incorporated into the intermediate space between the pans, without being in contact with the food.

1-18. (canceled)

19. A system for treating a food product by means of Pulsed Electric Field (PM, the system comprising:
(a) a treatment pan comprising:
(i) an upright sidewall, a bottom for receiving the food, a first and a second passage opening, and a removable cover;
(ii) a ground electrode positioned near the bottom and a voltage electrode positioned adjacent to the cover, forming an electrode chamber between the two electrodes,
(iii) a first power line connected to the earth electrode and a second power line connected to the voltage electrode, wherein the first and second power lines extend through the first and second passage openings, respectively, to the outside;
(b) a PEF-generator; and
(c) a coupling station arranged for receiving the treatment pan in the use position, the coupling station further comprising: a first connecting line to the PEF-generator of a pulsed electric field and a second connecting line to the PEF-generator, such that in the use position a pulsed electric field is transmitted from the PEF-generator through the connecting lines and through the power lines to the electrodes in the treatment pan.

20. The system according to claim 19, wherein the first and the second passage openings are provided in the bottom or in the cover of the treatment pan.

21. The system according to claim 19, wherein the first passage opening is provided in the bottom of the treatment pan and wherein the second passage opening is provided in the cover of the treatment pan.

22. The system according to claim 19, wherein the cover comprises a circumferential collar, wherein the voltage electrode is arranged against the lower edge of the circumferential collar, and wherein in the use position the circumferential collar extends into the interior of the treatment pan.

23. The system according to claim 22, wherein a collection chamber is provided in the radial direction between the circumferential collar and the upright sidewall of the treatment pan for collecting excess liquid from the electrode chamber of the treatment pan.

24. The system according to claim 19, wherein the coupling station further comprises a jaw element for receiving the treatment pan.

25. The system according to claim 24, wherein the jaw element comprises an upper jaw element and a lower jaw element.

26. The system according to claim 24, wherein the cover and/or bottom comprises one or more recesses for receiving one or more jaw elements of the coupling station.

27. The system according to claim 25, wherein the upper jaw element comprises the second connecting line for electrical connection to the second power line in the recess of the cover.

28. The system according claim 22, further comprising a second treatment pan detachably provided in the first treatment pan, whereby in the use position the earth electrode, the voltage electrode and the circumferential collar of the cover are provided in the second treatment pan.

29. The system according claim 19, wherein the treatment pan comprise food-grade polycarbonate.

30. The system according to claim 19, wherein the electrodes comprise nickel and the electrical lines comprise bronze,

31. The system according to claim 30, wherein the bronze is phosphor bronze.

32. The system according to claim 19, wherein the treatment pan further comprises a safety means, which can be read out by the coupling station so that the PEF-generator can only provide a pulsed electric field when a safe, suitable, configuration is inserted in the coupling station.

33. The system according to claim 32, wherein the safety means comprises a chip that can be read out or a communication network.

34. The system according to claim 19, wherein the treatment pan further comprises a control means, which can be read out by the coupling station so that the PEF-generator provides a pulsed electric field controlled by the data of the control means.

35. A treatment pan comprising:
(i) an upright sidewall, a bottom, a first and a second passage opening, and a removable cover;
(ii) a ground electrode positioned near the bottom and a voltage electrode positioned adjacent to the cover, forming an electrode chamber between the two electrodes,
(iii) a first power line connected to the earth electrode and a second power line connected to the voltage electrode, wherein the first and second power lines extend through the first and second passage openings, respectively, to the outside.

36. A coupling station for receiving the treatment pan in the use position, the coupling station further comprising: a first connecting line to a Pulsed Electric Field (PEF) generator of a pulsed electric field and a second connecting line to the PEF-generator, such that in the use position a pulsed electric field is transmitted from the PEF-generator through the connecting lines and through the power lines to the electrodes in the treatment pan.

37. A method for treating a food product, comprising applying a pulsed electric field to the food in a system according to claim 19.
